(19) United States
(12) Patent Application Publication
(10) Pub. No.: US 2010/0101390 A1
(43) Pub. Date: Apr. 29, 2010

(54) QUICK-RELEASE MECHANISM FOR SAW MACHINE

(75) Inventor: Cheng-Hung CHIU, Taichung (TW)

Correspondence Address: BACON & THOMAS, PLLC, 625 SLATERS LANE, FOURTH FLOOR, ALEXANDRIA, VA, 22314-1176, US

(73) Assignee: Rexon Industrial Corp., Ltd., Taichung (TW)

(21) Appl. No.: 12/604,540

(22) Filed: Oct. 23, 2009

(30) Foreign Application Priority Data
Oct. 27, 2008 (TW) 097141178

(51) Int. Cl. B27G 19/08

(52) U.S. Cl. 83/102.1; 83/701

(57) ABSTRACT

A quick-release mechanism for use in a saw machine includes a mounting member, which has a first surface, a second surface and a locating notch. A connection member has an inner positioning surface for abutting against the first surface of the mounting member and an insertion block extending from the inner positioning surface and is insertable into the locating notch of the mounting member. A locking device has a pivot member pivotally connected to the insertion block, an engagement portion connected to the pivot member corresponding to the second surface of the mounting member and a finger strip operable to move the engagement portion between a first position where the engagement portion is at an inner side of the insertion block and a second position where the engagement portion extends over the second surface of the mounting member to lock the connection member to the mounting member.

### FIELD OF THE INVENTION

The present invention relates to wood processing machinery and more particularly, to a quick-release mechanism for use in a saw machine.

### BACKGROUND

A saw machine generally has many safety devices to ensure operation safety. For example, a riving knife fixedly provided at the machine table behind the saw blade separates two cut pieces of wood, so as to eliminate kickback. Two check pawls may be respectively pivotally provided at two sides of the riving knife and configured to engage the workpiece to prohibit kickback of the cut pieces. A guard may be pivotally provided at the top side of the riving knife and extending over the top side of the saw blade to shield the top side of the saw blade.

In order to meet international safety codes, the installation and maintenance of the component parts of a saw machine are relatively complicated. To facilitate installation and maintenance, saw machine safety devices are commonly made detachable. In consequence, different quick-release mechanisms are extensively used with safety devices in saw machines.

According to the quick-release mechanisms of certain commercial saw machines, such as those described in TW M328333, TW I269680 (equivalent to U.S. Pat. No. 7,302,878), TW200823029 (equivalent to U.S. publication no. 2008/0121080) and TW M288213 (equivalent to U.S. Pat. No. 7,210,386), a lock pin is commonly used for single-point locking control. Further, according to the design shown in FIG. 1 (TW M288213), the quick-release mechanism comprises a locating hole 101 formed in a notch located on the top side of the riving knife 1. The notch has an open end and a closed end and an inner diameter of the closed end is greater than the size of the opening at the open end. A connection member 2 is located on the riving knife 1 for the pivotal connection of check pawls or a guard thereto. A pin 201 inserted through the connection member 2 has a neck 203, and a spring member 202 arranged concentrically on the pin 201 to impart a pressure to the pin 201 in order to hold the pin 201 in such a position where the neck 203 is maintained spaced from the locating hole 101 such that the pin 201 is retained in the locating hole 101, and the connection member 2 is maintained in position on the riving knife 1. This configuration of the single-point locking design of a quick-release mechanism is less stable. Further, the whole structure of the quick-release mechanism is complicated.

There are other known designs that eliminate the use of a spring means. For example, U.S. publication no. 2008/0022826 shows a spring free design, however the design is of a single-point locking type. Further, U.S. publication no. 2008/0047409 discloses a double-point locking design. According to this design, as shown in FIG. 2, the quick-release mechanism comprises two L-shaped locating holes 301 located on the top side of a riving knife 3. A connection member 4 is pivotally connected to a guard (not shown), and two blocks 5 are fixedly provided at the bottom side of the connection member 4 for attaching to the top side of the riving knife 3. Two pins 501 are respectively mounted in the blocks 5 for being received in the L-shaped locating holes 301. A knob 6 is mounted on the connection member 4 and is rotatable to tighten the connection member 4 to the riving knife 3. According to this design, a large amount of time is required to install and uninstall the quick-release mechanism.

### SUMMARY

The present disclosure has been accomplished under the circumstances in view. Thus, embodiments of the present disclosure provide a quick-release mechanism for a saw machine, which allows quick mounting and dismounting, and assures a high level of locking safety.

To achieve this and other objects, a quick-release mechanism for use in a saw machine comprises a mounting member, a connection member and a locking member. The mounting member has a first surface, a second surface opposite to the first surface, a top side joining one side of the first surface and one side of the second surface and extending in a first direction, and a locating notch disposed adjacent to the top side and extending through the first and second surfaces. The connection member is selectively attachable to the mounting member in a second direction perpendicular to the first direction, and has an inner positioning surface for abutting against the first surface of the mounting member and an insertion block extending from the inner positioning surface. The insertion block is insertable into the locating notch of the mounting member. The insertion block has a shape corresponding to the shape of the locating notch, and has a junction surface corresponding to the second surface of the mounting member. The locking device is adapted for locking the connection member to the mounting member, and includes a pivot member pivotally connected to the insertion block, an engagement portion connected to the pivot member and corresponding to the second surface of the mounting member, and a finger strip operable to move the engagement portion relative to the connection member. The finger strip is movable between a first position, where the engagement portion is at an inner side of the insertion block, and a second position, where the engagement portion extends over the second surface of the mounting member to lock the connection member to the mounting member.

By means of manipulating the finger strip of the locking member to move the engagement portion between the first and second positions, the connection member is locked or unlocked from the mounting member. Thus, this quick-release mechanism has a simple structure and is easy to operate.

### BRIEF DESCRIPTION OF THE DRAWINGS

Other advantages and features of the present invention will be understood by reference to the following specification in conjunction with the accompanying drawings, in which like reference characters denote like elements of structure.

FIG. 1 is a schematic installed view of a quick-release mechanism according to the prior art.

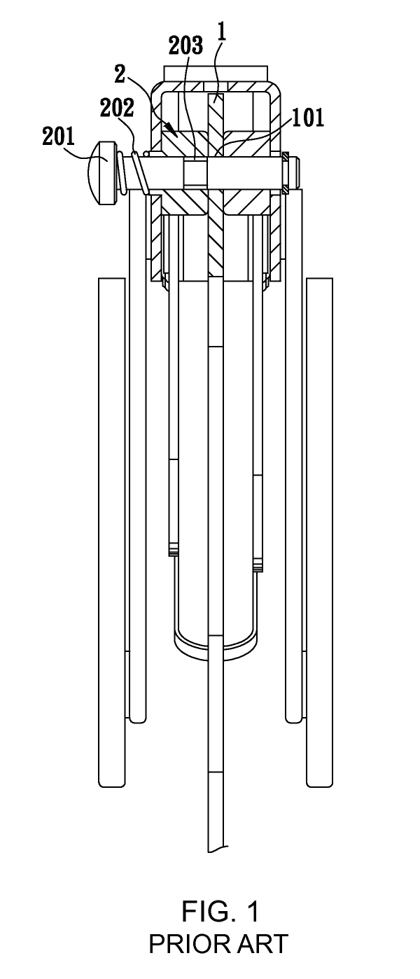

FIG. 2 is a schematic installed view of another structure of a quick-release mechanism according to the prior art.

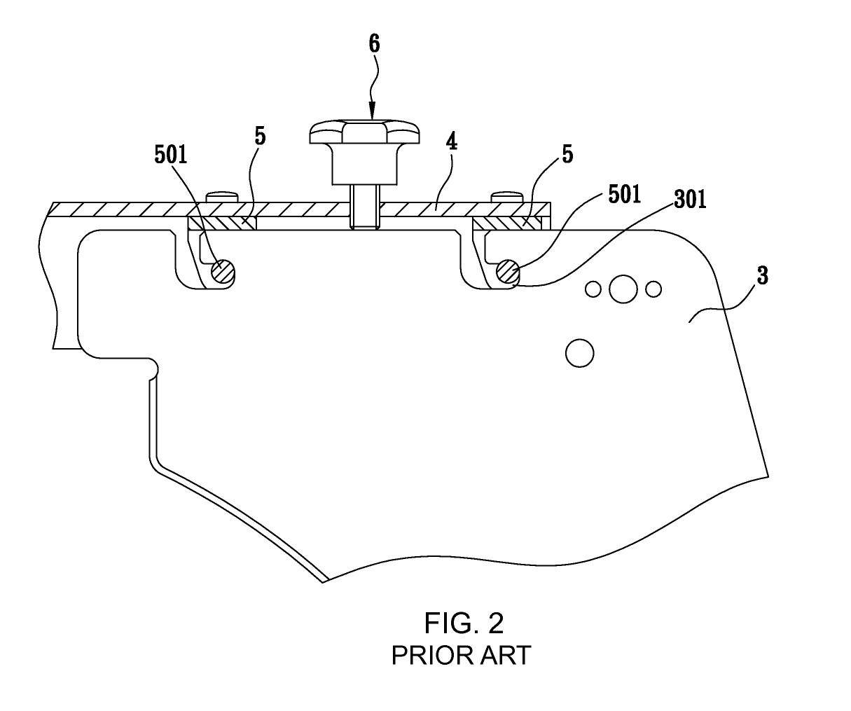

FIG. 3 is an exploded view of a quick-release mechanism in accordance with the present disclosure.

FIG. 4 is a perspective assembly view of the quick-release mechanism in accordance with the present disclosure.

FIG. 5 is a schematic front view of the present disclosure, showing the connection member of the quick-release mechanism attached to the mounting member.

FIG. 6 is a view similar to FIG. 5, showing the finger strip of the locking device moved from the first position to the second position and the engagement portion of the locking member moved from the unlocking position to the locking position.

FIG. 7 is a sectional view taken along line VII-VII of FIG. 6.

FIG. 8 is a schematic drawing of the present disclosure, showing the quick-release mechanism of the present disclosure used with a saw blade guard.

### DETAILED DESCRIPTION

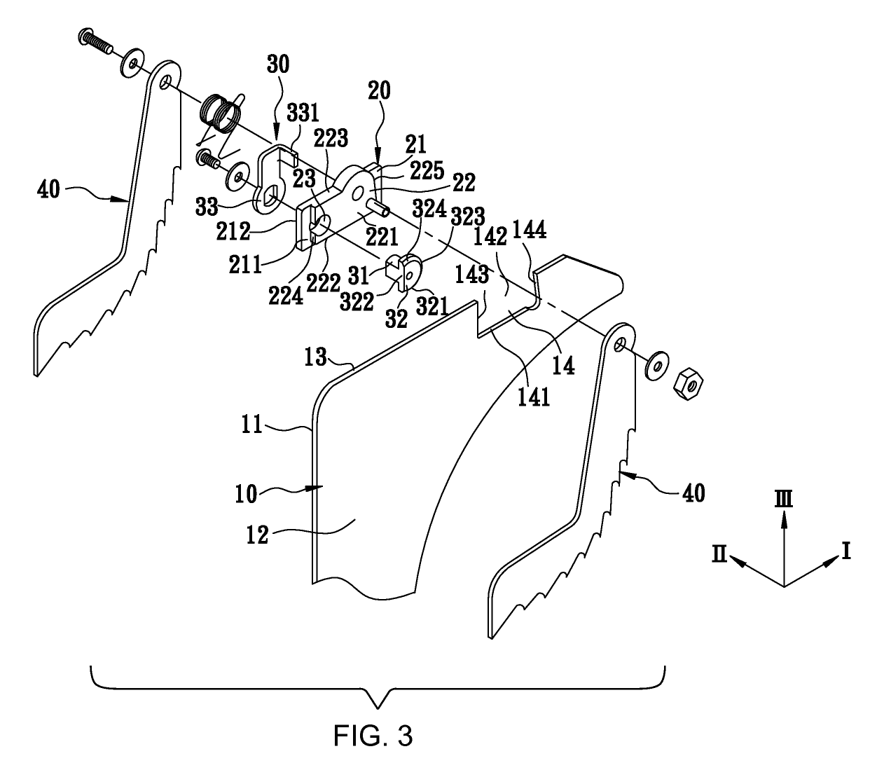

Referring to FIG. 3, a quick-release mechanism for use in a saw machine in accordance with the present disclosure is shown comprising a mounting member 10, a connection member 20, and a locking device 30 for locking the connection member 20 to the mounting member 10. According to this embodiment, the mounting member 10 is a riving knife. The connection member 20 is adapted for the pivotal connection of two check pawls 40 at two sides relative to the mounting member 10.

The mounting member 10 is a flat plate member having a first surface 11, a second surface 12 opposite to the first surface 11. A top side 13 joins the topmost edge of the first surface 11 and the topmost edge of the second surface 12 and extends in a first direction I. A locating notch 14 is positioned on the top side 13. The locating notch 14 extends through the first surface 11 and the second surface 12 in a second direction II perpendicular to the first direction I. The locating notch 14 is a single open end design, having a bottom edge 141, an opening 142 formed at the top side 13 of the mounting member 10, a straight side edge 143 disposed at one lateral side between the opening 142 and the bottom edge 141, and an oblique side edge 144 disposed at the other lateral side between the opening 142 and the bottom edge 141. The width of the bottom edge 141 is greater than the width of the opening 142 at the top side 13.

The connection member 20 is a flat plate member selectively attachable to the mounting member 10 in a second direction II perpendicular to the aforesaid first direction I. The connection member 20 has a base 21, an insertion block 22 extending from one side of the base 21 and a pivot hole 23 extending through the base 21 and the insertion block 22. The width of the base 21 as measured in the aforesaid first direction I is greater than the width of the locating notch 14 in the first direction I. The base 21 has an inner positioning surface 211 for abutting against the first surface 11, and an outer surface 212 opposite to the inner positioning surface 211. The insertion block 22 is generally configured to fit within the locating notch 14, and has a junction surface 221, which is maintained flush with the second surface 12 of the mounting member 10 after insertion of the insertion block 22 into the locating notch 14. A bottom edge 222 located on the bottom side of the junction surface 221 abuts against the bottom edge 141 of the locating notch 14. A top edge 223 opposite to the bottom edge 222 generally corresponds to the top side 13 of the mounting member 10. A first side edge 224 generally corresponds the straight side edge 143, and a second side edge 225 corresponding to the oblique side edge 144. The pivot hole 23 is located at the first side edge 224.

The locking device 30 comprises a pivot member 31 pivotally received in the pivot hole 23, a wheel 32 integrally formed with or fixedly connected to one end of the pivot member 31, and a handle 33 fixedly connected to the other end of the pivot member 31. The handle 33 is disposed at an outer side relative to the outer surface 212 of the base 21 of the connection member 20. The pivot member 31 is a stub rod inserted in the pivot hole 23 and passing through the junction surface 221 to the outside of the outer surface 212. The wheel 32 is a sector plate member, having a transverse edge 321 corresponding to the bottom edge 222 of the insertion block 22 and the bottom edge 141 of the locating notch 14, and a substantially planar vertical edge 322 extending vertically upwardly from one end of the transverse edge 321 and corresponding to the first side edge 224 of the insertion block 22 and the straight side edge 143 of the locating notch 14. The wheel 32 also includes a peripheral edge 323 connected between an end of the transverse edge 321 remotely spaced from the vertical edge 322 and an end of the vertical edge 322 remotely spaced from the transverse edge 321, and an engagement portion 324 defined in the connection area between the peripheral edge 323 and the vertical edge 322. Further, the distance L1 between the center of rotation of the pivot member 31 and the engagement portion 324 is greater than the distance L2 between the center of rotation of the pivot member 31 and the vertical edge 322. The handle 33 has an L-shaped finger strip 331 extending from the free end thereof and positioned above the top edge 223 of the connection member 20.

Referring to FIGS. 3, 5, and 6, during installation of the connection member 20 in the mounting member 10, the locking device 30 is arranged to have the transverse edge 321 and vertical edge 322 of the wheel 32 to be respectively disposed at an inner side relative to the bottom edge 222 and the first side edge 224 and the L-shaped finger strip 331 maintained in a first position located above the connection member 20. The insertion block 22 of the connection member 20 is then aligned with the locating notch 14 and the insertion block 22 is next inserted into the locating notch 14 in the direction from the first surface 11 toward the second surface 12 so that the inner positioning surface 211 abuts against the first surface 11. Simultaneously, the bottom edge 222, the first side edge 224 and the second side edge 225 respectively abut against the bottom edge 141, the straight side edge 143, and the oblique side edge 144 of the locating notch 14 respectively. Since the width of the bottom edge 141 is greater than the width of the opening 142, the insertion block 22 is connected to the mounting member 10 and is prevented from accidental removal from the mounting member 10 in a third direction III, perpendicular to the first direction I and the second direction II.

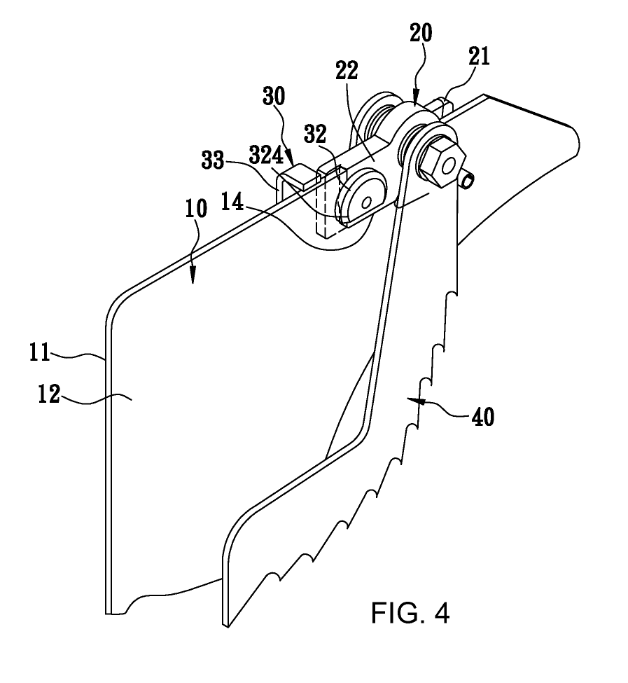

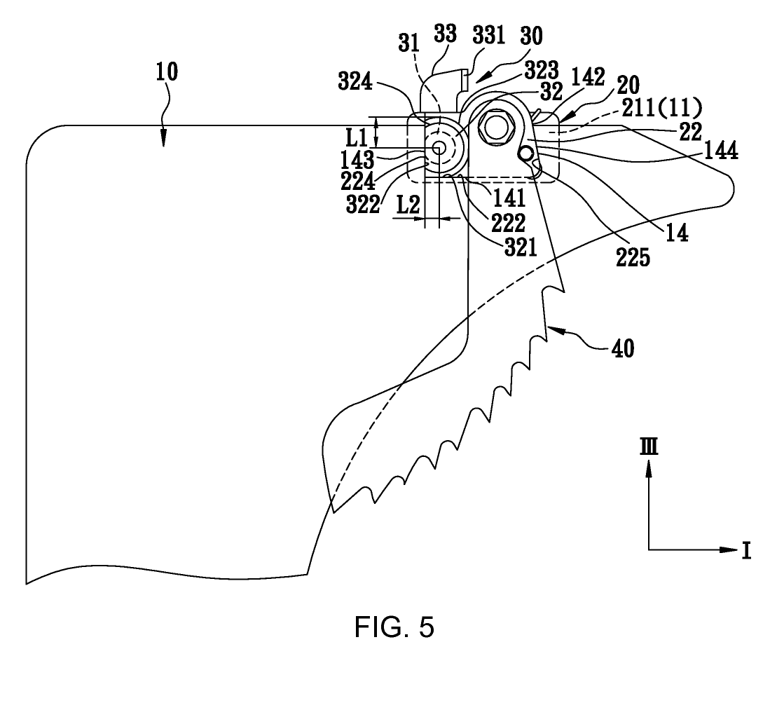

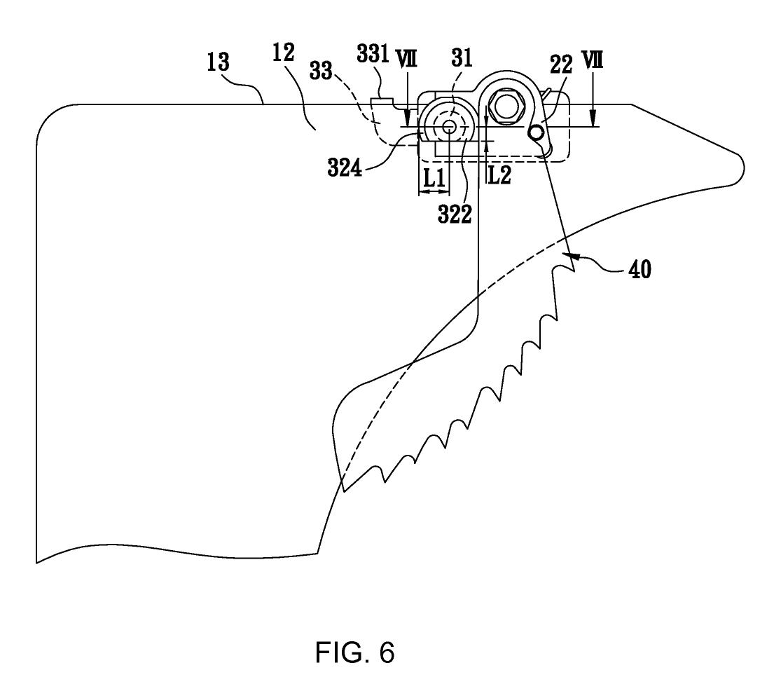

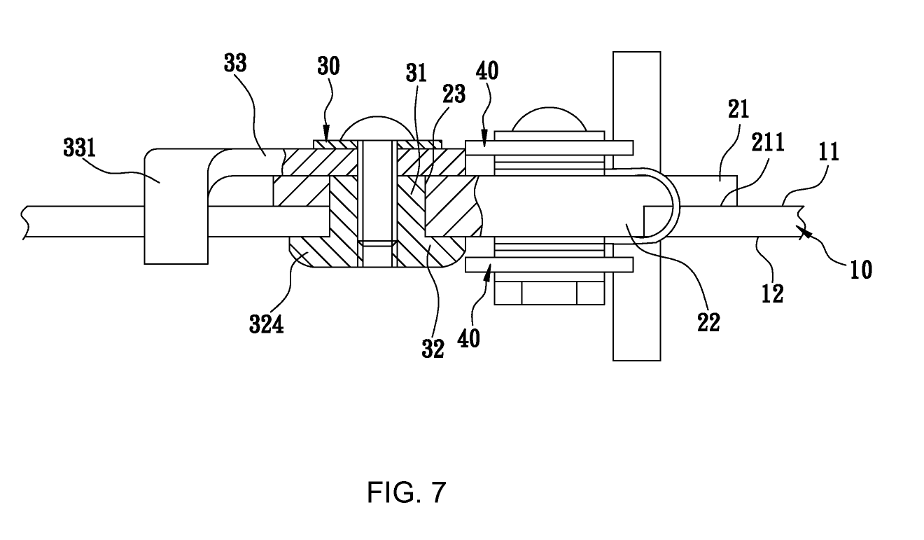

Thereafter, the user moves the finger strip 331 of the handle 33 from the first position to a second position (moving the finger strip 331 towards the top side 13). When the finger strip 31 reaches the second position, due to the fact that the distance L1 is greater than the distance L2, the engagement portion 324 is moved from the unlocking position at an inner side relative to the first side edge 224 of the insertion block 22 (see FIG. 5) to a locking position where the engagement portion 324 extends over the second surface 12 (see FIGS. 6 and 7), thereby locking the connection member 20 to the mounting member 10. At this time, the two check pawls 40 are properly positioned relative to the mounting member 10 (see FIG. 4).

To dismount the quick-release mechanism, the finger strip 331 is moved from the second position to the first position (from the status shown in FIG. 6 to that shown in FIG. 5) to move the engagement portion 324 from the locking position, where the engagement portion 324 extends over the second surface 12, to the unlocking position, where the engagement portion 324 is maintained at the inner side relative to the first side edge 224. Thus, the operation is quite simple.

Therefore, the quick-release mechanism of the present disclosure has the characteristics of simple structure, ease of fabrication, and ease of mounting and dismounting. By means of inserting the insertion block 22 into the locating notch 14 and bridging the engagement portion 324 over the second surface 12, a two-point locating function is achieved. Further, insertion of the insertion block 22 into the locating notch 14 or removal of the insertion block 22 from the locating notch 14 is achieved simply by means of moving the connection member 20 toward or away from the mounting member 10 without any other extra procedures.

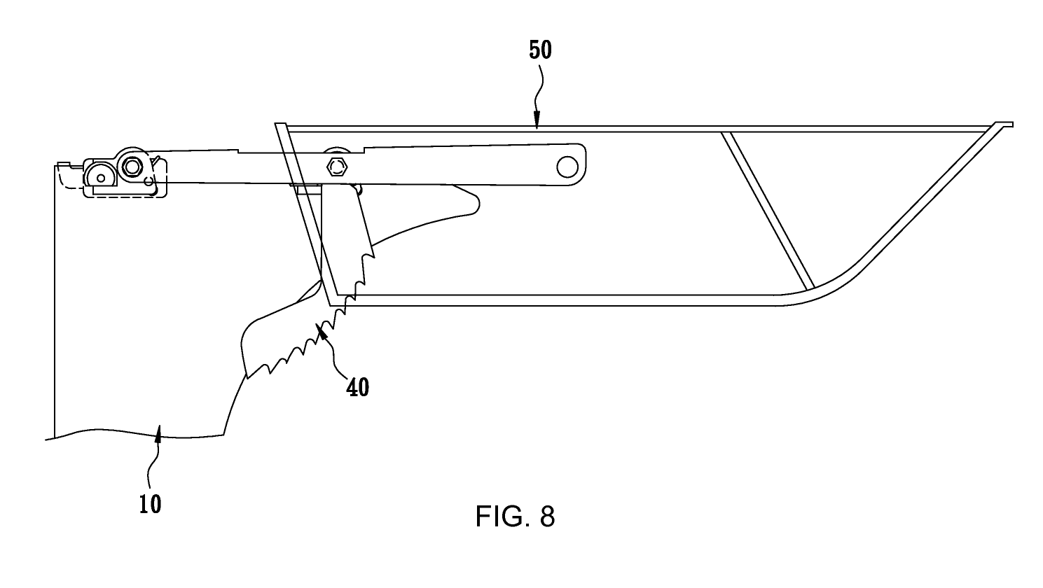

Referring to FIG. 8, the quick-release mechanism is practical for use to lock a saw blade guard 50 to the mounting member 10 (riving knife).

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A quick-release mechanism for use in a saw machine, comprising:
a mounting member having a first surface, a second surface opposite to said first surface, a top side joining one side of said first surface and one side of said second surface and extending in a first direction, and a locating notch disposed adjacent to said top side and extending through said first and second surfaces;
a connection member selectively attachable to said mounting member in a second direction perpendicular to said first direction, said connection member having an inner positioning surface for abutting against said first surface of said mounting member and an insertion block extending from said inner positioning surface and insertable into said locating notch of said mounting member, said insertion block corresponding in shape to the shape of said locating notch and having a junction surface corresponding to said second surface of said mounting member; and
a locking device locking said connection member to said mounting member, said locking device comprising a pivot member pivotally connected to said insertion block, an engagement portion connected to said pivot member and corresponding to said second surface of said mounting member, and a finger strip operable to move said engagement portion relative to said connection member, said finger strip moveable between a first position, whereat said engagement portion is positioned at an inner side of said insertion block, and a second position, whereat said engagement portion extends over said second surface to lock said connection member to said mounting member.

2. The quick-release mechanism as claimed in claim 1, wherein said locating notch of said mounting member includes a bottom edge and an opening formed on said top side of said mounting member, a width of said bottom edge of said locating notch is greater than a width of said opening.

3. The quick-release mechanism as claimed in claim 2, wherein said locating notch of said mounting member further has a straight side edge connected between said opening and bottom edge of said locating notch at a first lateral side and an oblique side edge connected between said opening and bottom edge of said locating notch at a second, opposite lateral side; said insertion block of said connection member has a bottom edge arranged for abutting against said bottom edge of said locating notch, a top edge opposite to said bottom edge of said insertion block, a first side edge corresponding to said straight side edge of said locating notch, and a second side edge corresponding to said oblique side edge of said locating notch.

4. The quick-release mechanism as claimed in claim 3, wherein said locking device further comprises a wheel fixedly connected to one end of said pivot member and a handle fixedly connected to an opposite end of said pivot member and disposed at an outer side relative to said connection member, said wheel being a sector plate member having a transverse edge corresponding to said bottom edge of said insertion block and said bottom edge of said locating notch, a vertical edge extending vertically upwardly from one end of said transverse edge and corresponding to said first side edge of said insertion block and said straight side edge of said locating notch and a peripheral edge connected between an opposite end of said transverse edge remotely spaced from said vertical edge and an opposite end of said vertical edge remotely spaced from said transverse edge; said engagement portion is defined in the connection area between said peripheral edge and said vertical edge; wherein a distance between the center of rotation of said pivot member and said engagement portion is greater than a distance between the center of rotation of said pivot member and said vertical edge; and wherein said finger strip extends from the free end of said handle above said top edge of said connection member.

5. The quick-release mechanism as claimed in claim 4, wherein said connection member has a base, said inner positioning surface of said connection member is located on said base, said base having a width greater than a width of said locating notch and an outer surface opposite to said inner positioning surface; said insertion block extends from one side of said base; and said pivot member of said locking device extends through said insertion block, said base, and said outer surface.

6. The quick-release mechanism as claimed in claim 1, wherein said mounting member is a riving knife.
